(19) United States
(12) Patent Application Publication
(10) Pub. No.: US 2010/0000098 A1
(43) Pub. Date: Jan. 7, 2010

(54) CLEAVER WITH UPSET-FORGED BOLSTER

(75) Inventor: Joachim Droese, Langenfeld (DE)

Correspondence Address: K.F. ROSS P.C., 5683 RIVERDALE AVENUE, SUITE 203 BOX 900, BRONX, NY, 10471-0900, US

(73) Assignee: ZWILLING J.A. HENCKELS AG, Solingen (DE)

(21) Appl. No.: 12/440,995

(22) PCT Filed: Jul. 20, 2007
(86) PCT No.: PCT/EP2007/006459

§ 371 Date: Mar. 12, 2009

(30) Foreign Application Priority Data
Sep. 12, 2006 (DE) 10 2006 042 658.4

(51) Int. Cl. B26B 3/00

(52) U.S. Cl. 30/308

(57) ABSTRACT

The present invention relates to a cleaver (8) having a crush-forged crank (6). In order to provide a cleaver having an improved manageability and surface feel, thereby preventing any possible injuries during the use of the cleaver, the invention proposes that the crank according to the invention extends from the handle (4) in the direction of the cutting edge (11) along the blade and/or edge surface (5) on the handle side.

The present invention relates to a cleaver with an upset-forged bolster.

Cleavers with an upset-forged bolster are known and are composed of a knife blade and/or a knife, a bolster and a handle, the handle being connected to the blade and/or knife via the bolster. Knives are also known in which the blade, the bolster and the tang are manufactured by upset-forging from a single blank.

FR 2,612,432 describes, for example, a process for the manufacture of a cleaver consisting of several elements in which a tang is connected via an upset-forged bolster to the knife blade. On the other hand, GB 692,042 describes a process for the manufacture of a knife in which the blank stamped out of a hard and rustproof material in one piece is processed to a knife with an upset-forged blade.

When using the known cleaver contact can occur between the fingers gripping the handle and the face of the knife blade and/or knife on the tang side. This can result in uncomfortable pressure points on the fingers because the tang region and/or blade face on the tang side does not have a form that fits the anatomy of the fingers.

This described disadvantage results in the object of the present invention of creating a cleaver that has a better handling and feel and thus prevents injuries when in use. Furthermore, the invention has the object of gain optimal use of the cutting edge while protecting the fingers.

The object is attained in that the bolster in accordance with the invention extends from the handle toward the cutting edge along the blade and/or knife face on the tang side.

This invention has the advantage that direct contact of finger and knife and/or blade is avoided and a better handling is created by special design of the bolster.

It is particularly advantageous if the bolster only partially covers the rear edge of the knife and/or blade face, the edge facing the handle, and the lower region of the edge ending at the cutting edge is not covered by the bolster. This results in on the one hand the fingers being protected from the knife and the blade and on the other hand the cutting edge being usable over its entire length. In addition, the rear blade end is sharp and can be used. It is advantageous if the lower edge region not covered by the bolster has a height of ½ to ⅚, especially ⅔ of the total height of the blade.

It is also suggested that the front edge of the bolster that rests on the side face of the blade extends obliquely in such a manner that the upper end of the edge is closer to the front end of the blade than the lower end of the edge. This results in an optimal distribution of force.

The cleaver in accordance with the invention can be designed in such a manner that the knife and/or blade face is/are of rectangular, triangular or trapezoidal shape or shaped as an irregular polygon and the cutting edge, the back, the tang edge and/or the tang edge of the blade can have a circularly arcuate or undulating shape. Furthermore, the knife or blade can be of a constant thickness or have a thickness decreasing and/or increasing in thickness from the back to the cutting edge or can have knife and/or blade faces that are curved inward or outward, or can have two differently formed knife and/or blade faces. In addition, the knife and/or blade face can be formed with a bore and/or a groove. Examples for the described formats are cleavers, choppers, hatchet-like cleavers, Asian/Chinese cooking knives or the like.

According to an advantageous embodiment the bolster and/or tang end of the blade has at least one region extending parallel to the back of the cleaver and thicker perpendicular to the axial elongation of the cleaver than the back edge of the blade. This creates a surface on which the fingers closest to the knife or blade can comfortably rest, so that, when the cleaver is used, a comfortable, controlled handling that avoids pressure points is ensured.

A further embodiment of the invention provides that the bolster extends on the back of the cleaver the full width of the knife or blade. In cleavers with a very wide blade it is not necessary that the bolster extend the full width of the blade at the tang edge. However, the bolster is designed in such a manner that it ensures comfortable manipulation of the cleaver by the hand. On the other hand, a bolster longer than the distance between the back and the cutting edge would impair functioning of the cleaver.

A further advantageous embodiment of the invention is a bolster that is located on the handle end between the handle and the cutting edge. This design serves for comfortable guiding of the finger making contact with it and additionally protects the finger from contact with any material or object at the cutting edge side.

According to a further advantageous embodiment of the invention a recess is formed on the bolster on the handle end between the handle and the cutting edge. This recess also serves for comfortable guiding of the finger making contact with it and at the same time offers protection to the finger from making contact with any material or object at the cutting edge.

A further embodiment of the bolster in accordance with the invention is a bolster designed on its front end as a surface complementary to the knife and/or blade face on the tang end. Hence, the bolster can be supported on the knife and/or blade face in order to create better stability and does not stand in the way of a simple cleaning of the cleaver since no offsets are produced in which contaminants could settle.

According to a further advantageous embodiment of the invention the cleaver is manufactured from a blank stamped in one piece from rustproof material by an upset forging process. This makes possible fewer steps for the manufacture and is thus less cost-intensive. In addition, this imparts great stability to the cleaver, which increases its service life. However, it is also conceivable that instead of this, the cleaver is made of several parts. The hardness and composition of the material used can vary in accordance with the requirements and needs.

A further advantageous embodiment of the invention has grips on the tang of the cleaver. They are connected to the tang by riveting or adhering and can consist of plastic, ceramic material or metal.

The following figures serve to further explain the present invention. Therein:

FIG. 1 is a side view of a prior-art cleaver with bolster,

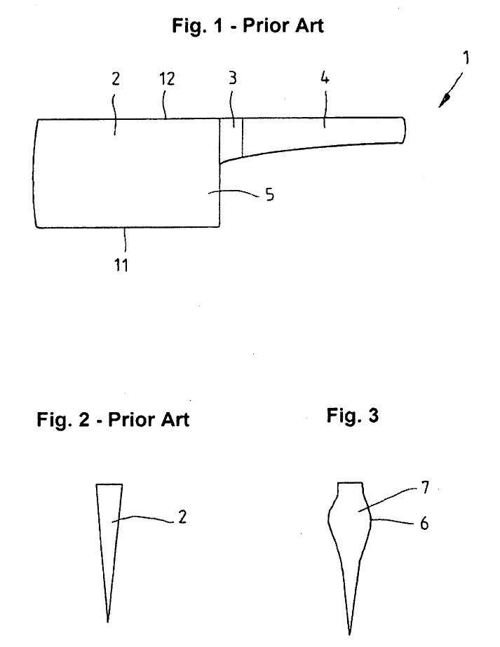

FIG. 2 is a cross section through the knife and/or of blade of a cleaver according to FIG. 1,

FIG. 3 is a cross section of a first embodiment of the bolster in accordance with the invention,

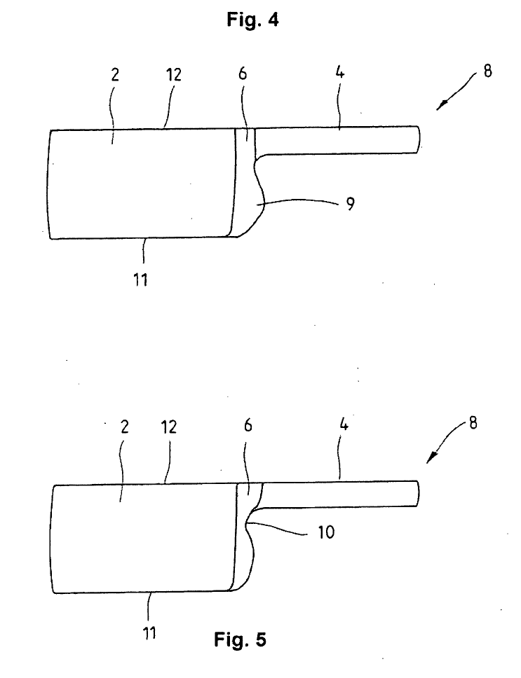

FIG. 4 is a side view of a cleaver in accordance with the invention with bolster and thickening,

FIG. 5 is a side view of a second cleaver in accordance with the invention with bolster and recess,

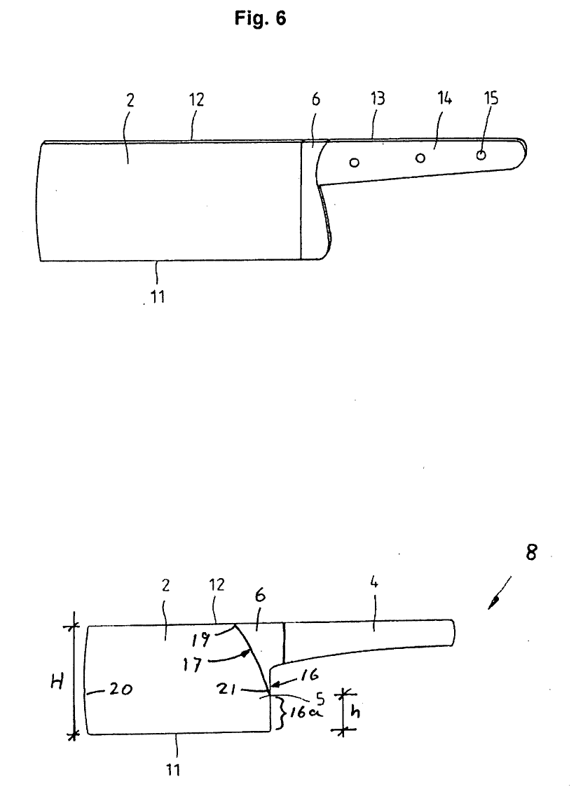

FIG. 6 is a perspective view of a third cleaver in accordance with the invention, and

FIG. 7 is a side view of a fourth embodiment of a cleaver in accordance with the invention.

FIG. 1 shows a prior-art cleaver 1 in a side view that consists of a knife or blade 2, a bolster 3, and a handle 4. The bolster 2 connects the knife and/or blade 2 and the handle 4 and is shaped as shown in FIG. 2 in cross section. When this cleaver 1 is used, a finger can contact a face 5 of the knife and/or of the blade 2 at the rear tang end. This face 5 does not fit the anatomy of the fingers, so that the cleaver 1 is uncomfortable to handle.

FIG. 3 shows a bolster 6 in accordance with the invention that deviates from the cross-sectional face of the knife and/or of the blade 2 at a thickened region 7. This can avoid uncomfortable pressure points occurring during use of the cleaver on the finger resting on it since the finger rests on the thicker region 7.

A further advantageous embodiment of cleaver 8 of the invention is shown in FIG. 4, where a bolster 6 in accordance with the invention has a part 9 projecting toward the handle. This projection 9 serves for the reliable guiding of the finger when handling the cleaver 8 and at the same time gives protection to a finger that might come in contact with objects or material located on the work side of the knife and/or of the blade 2.

FIG. 5 shows a cleaver 8 in accordance with the invention whose bolster 6 is formed with a recess 10 underneath the handle, making possible a reliable guiding of a finger that is simultaneously better protected against contact with objects or material at the work side.

FIG. 6 shows a perspective view of a cleaver 8 in accordance with the invention in which grips 14 are attached on the left and right sides of the tang 13 and are connected in this embodiment by rivets 15 to the tang 13.

FIG. 7 shows a side view of a cleaver in accordance with the invention in which the bolster 6 does not cover all the rear edge 16 facing the handle 4 over its entire height H but rather a lower portion 16a of the edge 16 running to a cutting edge 11 and having a height h is not covered by the bolster 6. Here the height h is equal to ½ to ⅚, especially ⅔ of the height H. It is also advantageous if a bolster front edge 17 resting on a side face of the blade 2 extends obliquely in such a manner that an upper end 19 of the edge 17 is closer to a front edge 20 of the blade 2 than a lower end 21 of the edge 17.

The described illustrated embodiment serves only for explanation and is not limiting.

1-11. (canceled)

12. A cleaver comprising:
a blade having a longitudinally extending back, a longitudinally extending cutting edge, a transversely extending cutting edge bridging the back and cutting edge, a rear edge also bridging the back and cutting edges, and a pair of oppositely directed faces bounded by the back and edges;
a tang projecting longitudinally from the rear edge adjacent the back; and
a thickened bolster between the tang and the blade, extending transversely from the tang toward the cutting edge, and having an obliquely extending front edge with an upper end and a lower end, the upper end being closer to the front edge of the blade than the lower end.

13. The cleaver defined in claim 12 wherein the bolster extends from the tang only over a portion of the rear edge and a lower end region of the rear edge is not covered by the bolster.

14. The cleaver defined in claim 12 wherein the lower end region has a transverse height equal to between ½ and ⅚ of an overall transverse height of the blade measured between the back and the cutting edge.

15. The cleaver defined in claim 14 wherein the transverse height of the lower end region is about ⅔ the overall transverse height of the blade.

16. The cleaver defined in claim 12 wherein the bolster has a thickened ridge extending longitudinally on the faces of the blade parallel to and offset toward the cutting edge from the back.

17. The cleaver defined in claim 12 wherein the bolster extends transversely from the tang all the way to the cutting edge.

18. The cleaver defined in claim 17 wherein the bolster is formed between the tang and the cutting edge with a rearward projection.

19. The cleaver defined in claim 17 wherein the bolster is formed between the tang and the cutting edge with a rearwardly open recess.

20. The cleaver defined in claim 12 has a front end toward the knife or blade formed with a surface that is complementary to the blade face at the end.

21. The cleaver defined in claim 12 wherein the blade, tang, and bolster are unitary and the bolster is formed by upset forging.

22. The cleaver defined in claim 12, further comprising:
grips fastened to the tang.
